(19) United States
(12) Patent Application Publication
(10) Pub. No.: US 2017/0300908 A1
(43) Pub. Date: Oct. 19, 2017

(54) COMMODITY SALES DATA PROCESSING APPARATUS AND METHOD FOR PROCESSING VALIDATION COMMODITY BY THE SAME

(71) Applicant: TOSHIBA TEC KABUSHIKI KAISHA, Tokyo (JP)

(72) Inventors: Seiji Ishikawa, Ebina (JP); Shinya Namura, Mishima (JP); Masato Oishi, Numazu (JP); Shuji Takahashi, Mishima (JP)

(21) Appl. No.: 15/098,580

(22) Filed: Apr. 14, 2016

(51) Int. Cl. G06Q 20/40

(52) U.S. Cl. CPC G06Q 20/405; G06Q 20/4012

(57) ABSTRACT

A commodity sales data processing apparatus comprises a commodity sales module configured to execute a commodity sales processing relating to payment of a validation commodity of which a PIN (Personal Identification Number) code is validated at the time the payment is confirmed; a sending module configured to send identification information capable of identifying the validation commodity after the payment is confirmed in the commodity sales module; a receiving module configured to receive validation commodity information read by an information processing apparatus that sends the PIN code to a server of a company that provides a sales item in order to receive the sales item indicated by the validation commodity identified by the identification information sent from the sending module; and a writing module configured to write the validation commodity information received by the receiving module in an IC (Integrated Circuit) tag on the validation commodity.

### FIELD

Embodiments described herein relate generally to a commodity sales data processing apparatus and a method for processing a validation commodity such as a prepaid card by the commodity sales data processing apparatus.

### BACKGROUND

In recent years, the number of retail stores in each of which a prepaid card is displayed to sell the same is increasing. For example, the prepaid card includes a prepaid card for downloading music, a prepaid card for downloading a game and a prepaid card for charging electronic money.

Specifically, many retail stores sell a prepaid card of which a PIN (Personal Identification Number) code thereof is validated at the time payment is confirmed in a POS (Point Of Sales) terminal. A customer who purchases the prepaid card can download a game or charge electronic money by inputting the validated PIN code at a predetermined Website. Hereinafter, the prepaid card using a technology in which the PIN code is validated at the time the payment is confirmed in the POS terminal is referred to as a ‘validation card’.

First, the customer scrapes a scratch-print on the validation card when the payment is confirmed in the POS terminal. Next, the customer displays a designated Website at which a PIN code is input. Then, the customer inputs the PIN code which appears on the validation card by scraping the scratch-print at the displayed Website. In this way, the customer can download a commodity or item indicated by the validation card or charge electronic money.

Thus, it is necessary for the customer to execute various input jobs, for example, input of the PIN code at the Website with the use of an information processing apparatus and therefore improvement for reducing input jobs is required.

### DESCRIPTION OF THE DRAWINGS

FIG. 1 is a schematic constitution diagram illustrating a validating system according to the present embodiment;

FIG. 2 is a block diagram exemplifying a hardware structure of a POS terminal;

FIG. 3 is a block diagram exemplifying a hardware structure of a store server;

FIG. 4 is a conceptual diagram exemplifying a data structure of a commodity master file;

FIG. 5 is a block diagram exemplifying a hardware structure of a validating server;

FIG. 6 is a conceptual diagram exemplifying a data structure of a validation card master file;

FIG. 7 is a block diagram exemplifying a hardware structure of a company server;

FIG. 8 is a conceptual diagram exemplifying a data structure of a PIN code master file;

FIG. 9 is a block diagram exemplifying a hardware structure of a validation card;

FIG. 10 is a block diagram exemplifying a hardware structure of a customer terminal;

FIG. 11 is a block diagram illustrating functional components of each apparatus included in the validating system;

FIG. 12 is an illustration diagram exemplifying a PIN code input screen;

FIG. 13 is a flowchart illustrating procedures of a checkout processing;

FIG. 14 is a flowchart illustrating procedures of a validating processing; and

FIG. 15 is a flowchart illustrating procedures of a commodity providing processing.

### DETAILED DESCRIPTION

A commodity sales data processing apparatus of an embodiment comprises a commodity sales module, a sending module, a receiving module and a writing module. The commodity sales module executes a commodity sales processing relating to payment of a validation commodity of which a PIN (Personal Identification Number) code is validated at the time the payment is confirmed. The sending module sends identification information capable of identifying the validation commodity after the payment is confirmed in the commodity sales module. The receiving module receives validation commodity information read by an information processing apparatus that sends the PIN code to a server of a company that provides a sales item in order to receive the sales item indicated by the validation commodity identified by the identification information sent from the sending module. The writing module writes the validation commodity information received by the receiving module in an IC (Integrated Circuits) tag attached to the validation commodity.

Hereinafter, the present embodiment is described with reference to the accompanying drawings.

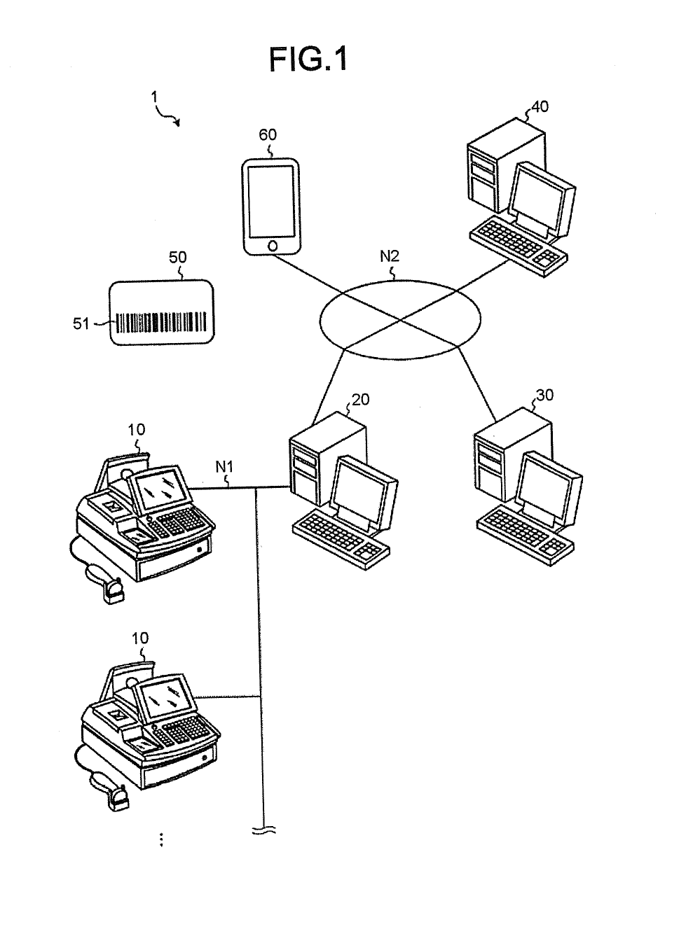

FIG. 1 is a schematic constitution diagram of a validating system 1 according to the present embodiment. The validating system 1 includes a POS terminal 10, a store server 20, a validating server 30, a company server 40, a validation card 50 and a customer terminal 60.

The POS terminal 10 is arranged in a store in which commodities such as a validation card 50 are sold. The POS terminal 10 is a commodity sales data processing apparatus for executing a sales registration processing for a commodity. The store server 20 collectively manages data received from the POS terminal 10 and other data to execute a sales management, a stock management and a cost management of the store. The store server 20 and the POS terminal 10 are connected with each other to perform a communication through an in-store network N1 such as a LAN (Local Area Network).

The validating server 30 manages the validating processing of the validation card 50. In the validating processing, the validating server 30 validates the PIN (Personal Identification Number) code associated with the validation card 50. Then, the validating server 30 replies the validated PIN code.

The company server 40 is managed by a company which supplies the validation card 50. Further, the company server 40 manages a Website for supplying a commodity indicated by the validation card 50 as a sales item to the customer. The supply of a commodity refers to a state in which the charge of electronic money or the download of a commodity can be executed.

The validation card 50 serving as a validation commodity is a prepaid card using a technology in which the PIN code printed on the validation card 50 at the time the payment is confirmed in the POS terminal 10. More specifically, the validation card 50 is a prepaid card which can receive the supply of a commodity indicated by the validation card 50 as a sales item by sending the PIN code to the company server 40 of the company which supplies the validation card 50 after the payment is confirmed. Furthermore, not limited to a commodity, the validation card 50 may indicate a service as a sales item.

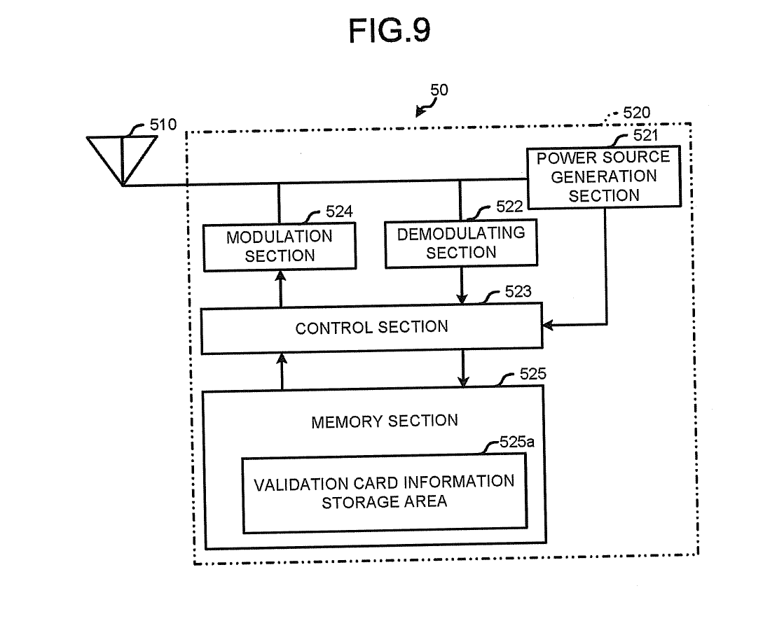

The validation card 50 includes a code symbol 51 and an IC (Integrated Circuit) tag 520 (refer to FIG. 9). The code symbol 51 is a figure containing a commodity code and a validation card code. The commodity code refers to identification information capable of identifying a commodity. Specifically, the commodity code is the identification information which is used by the store selling the validation card 50 to identify a commodity. The validation card code refers to identification information capable of identifying a validation card 50. Specifically, the validation card code is the identification information which is used by the validating server 30 to identify a validation card 50.

In the IC tag 520, information to be read by the customer terminal 60 is written to receive the supply of a sales item indicated by the validated card 50 on which a PIN code replied by the validating server 30 is printed.

The customer can receive the supply of the sales item indicated by the validation card 50 through inputting the PIN code written in the IC tag 520 at the Website.

The customer terminal 60 is an information processing apparatus such as a smart phone used by the customer. The customer terminal 60 can read the PIN code written in the IC tag 520. Further, the customer terminal 60 can access the Website managed by the company server 40 to input the PIN code to the accessed Website. Not limited to the smart phone, the customer terminal 60 may be a personal computer.

The store server 20, the validating server 30, the company server 40, and the customer terminal 60 are connected with one another to perform a communication through a network N2 such as an internet or a VPN (Virtual Private Network).

In the validating system 1, the POS terminal 10 reads a code symbol 51 of the validation card 50 which indicates the sales item selected by the customer. The POS terminal 10 sends, through the store server 20, the validation card code to the validating server 30 if the payment of the validation card 50 is confirmed. The validating server 30 validates the PIN code associated with the validation card code. Then, the validating server 30 replies the validated PIN code. The POS terminal 10 writes the PIN code replied by the validating server 30 in the IC tag 520 of the validation card 50.

The customer terminal 60 inputs the PIN code read from the IC tag 520 at a specific or designated Website. The company server 40 running the specific Website inquires of the validating server 30 whether or not the PIN code is valid. The validating server 30 replies to the company server 40 that the PIN code is valid or invalid. In a case in which the PIN code is valid, the company server 40 supplies a commodity associated with the PIN code to the customer. On the other hand, in a case in which the PIN code is invalid, the company server 40 does not supply the commodity associated with the PIN code to the customer. In this way, the validating system 1 closes a commodity transaction using the validation card 50.

Next, the hardware structure of each foregoing apparatus is described.

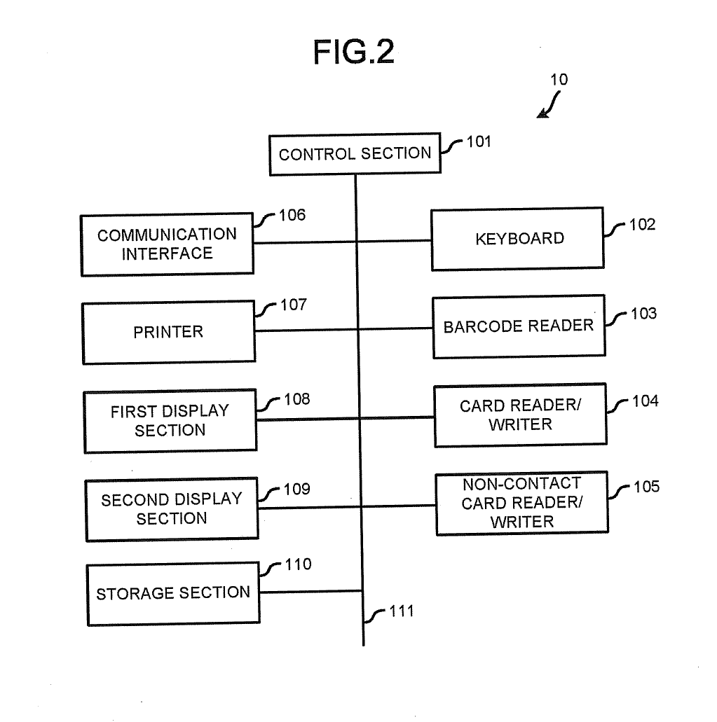

First, the POS terminal 10 is described. FIG. 2 is a block diagram exemplifying a hardware structure of the POS terminal 10.

The POS terminal 10 includes a control section 101 which has a computer structure consisting of a CPU, a ROM and a RAM. The control section 101 is connected with a keyboard 102, a barcode reader 103, a card reader/writer 104, a non-contact card reader/writer 105, a communication interface 106, a printer 107, a first display section 108, a second display section 109 and a storage section 110 through a bus line 111.

The keyboard 102 is used to input various kinds of information for operating the POS terminal 10. The keyboard 102 includes numeric keys, a clear key, a return key, a closing key and a cash total key. The numeric keys are used to input numerals such as a commodity code or an amount. The clear key is used to cancel an operation at the time an error occurs. The return key is used to cancel the current operation to return to a screen just before the operation is executed. The closing key is used to declare the calculation of the total amount of sales after the sales registration is completed. The cash total key is operated after a deposit amount is input to register the deposit amount. Then, if the cash total key on the keyboard 102 is pressed, the POS terminal 10 determines that the payment of the validation card 50 is confirmed.

The barcode reader 103 optically reads a barcode attached to the commodity. The card reader/writer 104 reads/writes data from or to a magnetic-storage type point card.

The non-contact card reader/writer 105 establishes a wireless communication with the validation card 50 if the validation card 50 (non-contact IC card) is held over the non-contact card reader/writer 105. Then, the non-contact card reader/writer 105 executes reading/writing of information from or to the validation card 50. More specifically, the non-contact card reader/writer 105 executes reading/writing of information stored in the IC tag 520 (refer to FIG. 9) of the validation card 50 through a short-distance wireless communication such as an NFC (Near Field Communication).

The communication interface 106 controls communication through the in-store network N1. The printer 107 prints a receipt. The first display section 108 is, for example, a liquid crystal display, used by a store clerk. Further, in the first display section 108, the touch panel is laminated on the display screen. The second display section 109 is, for example, a liquid crystal display, used by the customer. Further, in the second display section 109, the touch panel is laminated on the display screen. The storage section 110 is a storage device such as an HDD (Hard Disk Drive) or an SSD (Solid State Drive).

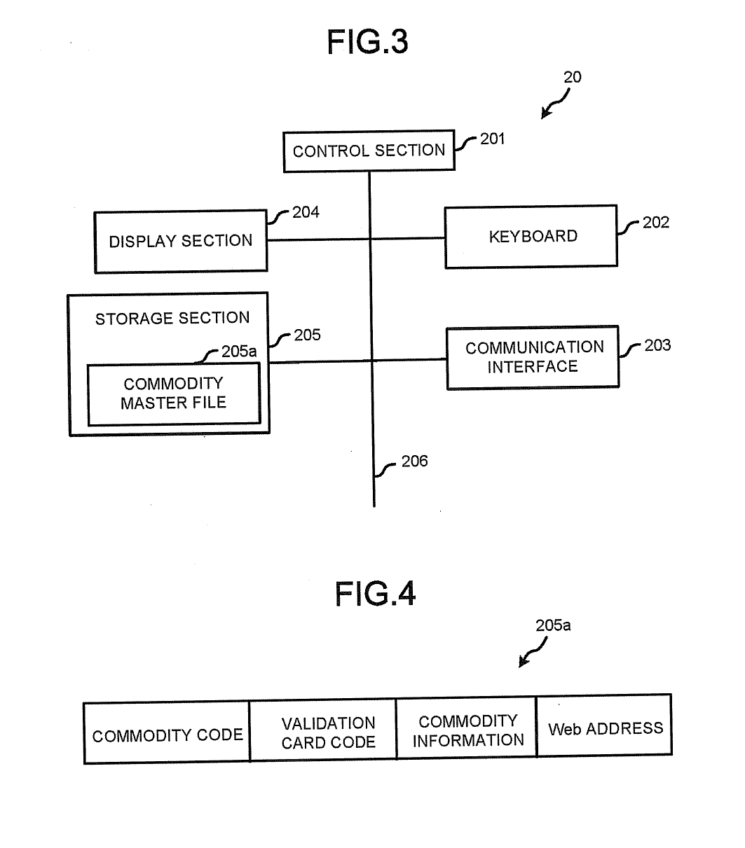

Next, the store server 20 is described. FIG. 3 is a block diagram exemplifying a hardware structure of the store server 20.

The store server 20 includes a control section 201 which has a computer structure consisting of a CPU, a ROM and a RAM. The control section 201 is connected with a keyboard 202, a communication interface 203, a display section 204 and a storage section 205 through a bus line 206.

The keyboard 202 is used to input various kinds of information for operating the store server 20. The communication interface 203 controls communication through the in-store network N1 and the network N2. The display section 204 is, for example, a liquid crystal display. The storage section 205 is a storage device such as an HDD or an SSD.

The storage section 205 stores a commodity master file 205a. FIG. 4 is a conceptual diagram exemplifying a data structure of the commodity master file 205a. The commodity master file 205a contains a commodity code, a validation card code, commodity information and a Web address. The commodity code is identification information capable of identifying a commodity. The validation card code is identification information capable of identifying the validation card 50. The commodity information relates to a commodity. The commodity information includes, for example, a commodity name, a commodity price and the like. The Web address is an address of a Website at which the PIN code is input.

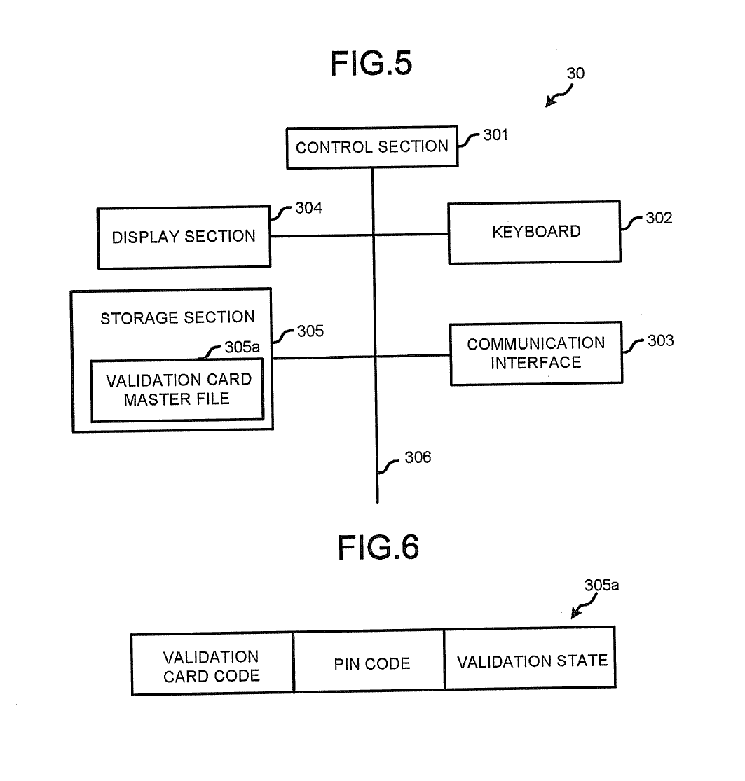

Next, the validating server 30 is described. FIG. 5 is a block diagram exemplifying a hardware structure of a validating server 30.

The validating server 30 includes a control section 301 which has a computer structure consisting of a CPU, a ROM and a RAM. The control section 301 is connected with a keyboard 302, a communication interface 303, a display section 304 and a storage section 305 through a bus line 306.

The keyboard 302 is used to input various kinds of information for operating the validating server 30. The communication interface 303 controls communication through the network N2. The display section 304 is, for example, a liquid crystal display. The storage section 305 is a storage device such as an HDD or an SSD.

The storage section 305 stores a validation card master file 305a. FIG. 6 is a conceptual diagram exemplifying a data structure of the validation card master file 305a. The validation card master file 305a contains a validation card code, a PIN code, a validation state. The validation card code is identification information capable of identifying the validation card 50. The PIN code is a password number for receiving the supply of a commodity indicated by the validation card 50. The validation state indicates whether or not the PIN code is valid.

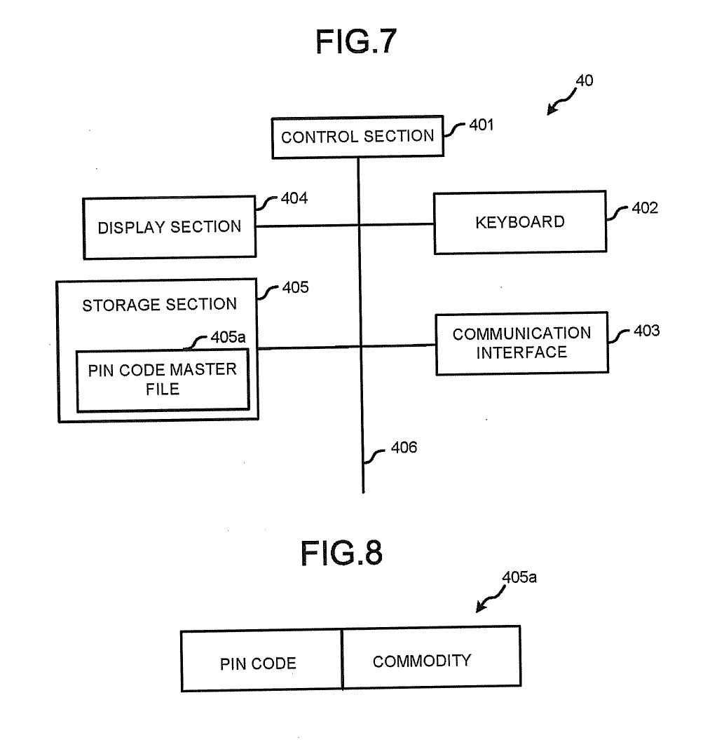

Next, the company server 40 is described. FIG. 7 is a block diagram exemplifying a hardware structure of the company server 40.

The company server 40 includes a control section 401 which has a computer structure consisting of a CPU, a ROM and a RAM. The control section 401 is connected with a keyboard 402, a communication interface 403, a display section 404 and a storage section 405 through a bus line 406.

The keyboard 402 is used to input various kinds of information for operating the company server 40. The communication interface 403 controls communication through the network N2. The display section 404 is, for example, a liquid crystal display. The storage section 405 is a storage device such as an HDD or an SSD.

The storage section 405 stores a PIN code master file 405a. FIG. 8 is a conceptual diagram exemplifying a data structure of the PIN code master file 405a. The PIN code master file 405a contains a PIN code and a commodity item. The PIN code is the same as that described above. The commodity item is, for example, electronic money, a game, music and the like.

In the PIN code master file 405a, no amount is set in the commodity item in a case in which the validation card 50 adopts a variable system which can set any amount in the amount of the electronic money purchased by the validation card 50. Then, the company server 40 sets the amount set in the POS terminal 10 in the commodity item at the time of executing the validating processing.

Next, the hardware structure of the validation card 50 is described. FIG. 9 is a block diagram exemplifying the hardware structure of the validation card 50.

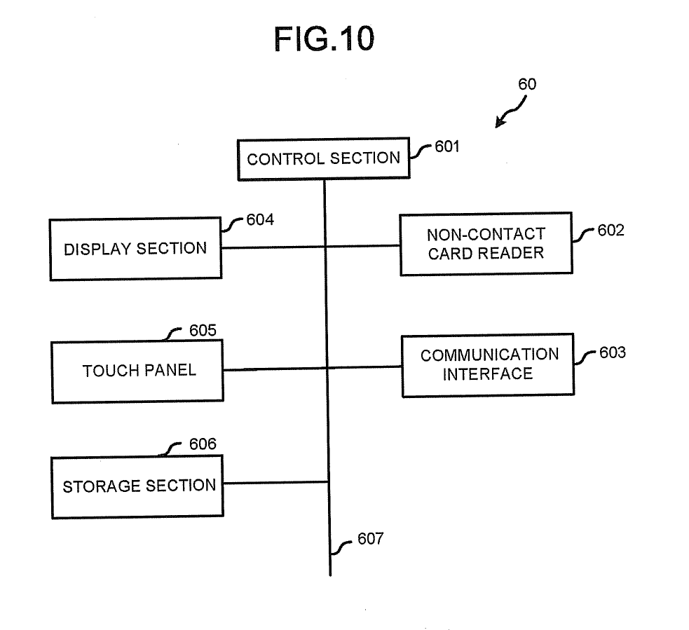

The validation card 50 includes an antenna 510 and the IC tag 520. The antenna 510 receives modulation wave transmitted from the non-contact card reader/writer 105 of the POS terminal 10 or a non-contact card reader 602 (refer to FIG. 10) of the customer terminal 60. The IC tag 520 includes a power source generation section 521, a demodulating section 522, a control section 523, a modulation section 524 and a memory section 525.

The power source generation section 521 generates electric power with the use of the modulation wave received by the antenna 510 from the non-contact card reader/writer 105 of the POS terminal 10 or the non-contact card reader 602 of the customer terminal 60. Then, the power source generation section 521 supplies the electric power to each section of the IC tag 520. The demodulating section 522 demodulates the modulation wave and outputs the demodulated wave to the control section 523. The control section 523 controls the writing to the memory section 525 and the reading of the information stored in the memory section 525. The modulation section 524 modulates information output from the control section 523 to output the modulated information to the antenna 510.

The memory section 525 is a non-volatile rewritable recording medium such as an EEPROM (Electrically Erasable Programmable Read Only Memory). The memory section 525 includes a validation card information storage area 525a. The validation card information storage area 525a stores information that is input to the customer terminal 60 to receive the supply of a sales item indicated by the validation card 50.

Next, the customer terminal 60 is described. FIG. 10 is a block diagram exemplifying a hardware structure of the customer terminal 60.

The customer terminal 60 includes a control section 601 which has a computer structure consisting of a CPU, a ROM and a RAM. The control section 601 is connected with the non-contact card reader 602, a communication interface 603, a display section 604, a touch panel 605 and a storage section 606 through a bus line 607.

The non-contact card reader 602 establishes a wireless communication with the validation card 50 if the validation card 50 (non-contact IC card) is held over the non-contact card reader 602. The non-contact card reader 602 reads out information from the validation card 50. More specifically, the non-contact card reader 602 reads out information stored in the IC tag 520 of the validation card 50 through a short-distance wireless communication such as an NFC.

The communication interface 603 controls the communication through the network N2. The display section 604 is, for example, a liquid crystal display. The touch panel 605 is laminated on the display section 604. The touch panel 605 is used to input various kinds of information for operating the customer terminal 60. The customer terminal 60 may include an input device, for example, a keyboard for inputting various operations. The storage section 606 is a storage device such as an HDD or an SSD.

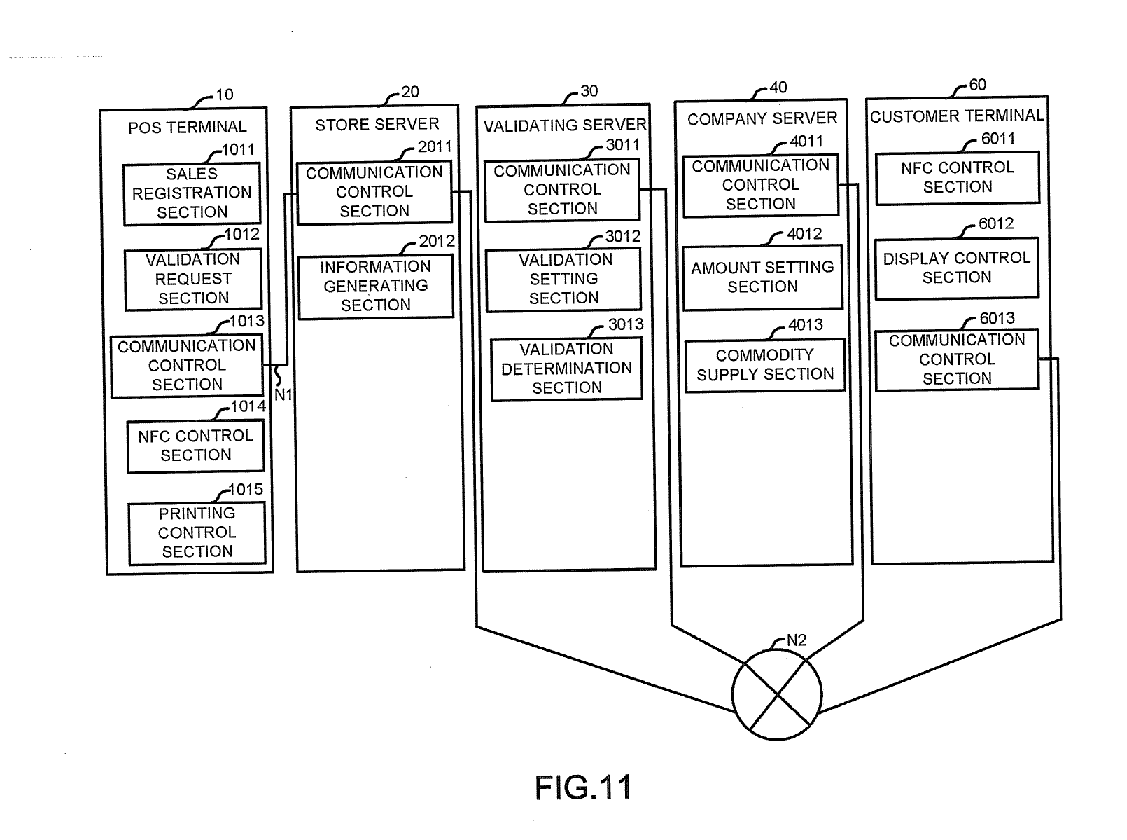

Next, functional components of each apparatus included in the validating system 1 are described. FIG. 11 is a block diagram illustrating functional components of each apparatus included in the validating system 1.

First, functional components of the POS terminal 10 are described. The CPU of the control section 101 copies or decompresses programs in the storage section 110 on the RAM and generates each functional section shown in FIG. 11 on the RAM according to the programs. Specifically, the POS terminal 10 includes, as functional sections, a sales registration section 1011, a validation request section 1012, a communication control section 1013, an NFC control section 1014 and a printing control section 1015.

The sales registration section 1011 serving as a commodity sales module executes a commodity sales processing relating to the payment for a commodity containing a commodity code input. Specifically, the sales registration section 1011 receives the input of the commodity code through the barcode reader 103 or the keyboard 102. The sales registration section 1011 receives the input for confirming the payment of the validation card 50 through input of the cash total key on the keyboard 102 if the payment by the customer is received by the store clerk. The sales registration section 1011 sales-registers the commodity code of the commodity the payment of which is executed in a sales master file (not shown). Further, the sales registration section 1011 sales-registers a commodity code contained in the code symbol 51 and the validation card code in the sales master file in the case of the validation card 50.

The validation request section 1012 requests a validating processing if the sales-registered commodity contains the validation card 50 at the time the payment of the validation card 50 is confirmed. Specifically, the validation request section 1012 requests the communication control section 1013 to send the validation card code to the store server 20 if the cash total key on the keyboard 102 is pressed and the payment is confirmed.

The communication control section 1013 controls the communication interface 106 to connect with the in-store network N1. In this way, the communication control section 1013 communicates with the store server 20. Specifically, the communication control section 1013 serving as a sending module sends, through the store server 20, the validation request information to the validating server 30 according to the request of the validation request section 1012 after the payment is confirmed in the sales registration section 1011. The validation request information refers to information which requests the validation of the PIN code associated with the validation card code. The validation request information includes the validation card code.

Further, the communication control section 1013 sends, though the store server 20, the amount information indicating the set amount to the company server 40 if the validation card 50 with a variable system is sales-registered.

Further, the communication control section 1013 serving as a receiving module receives the validation card information from the store server 20 as a reply of the validation request information. The validation card information (validation commodity information) refers to information read by the customer terminal 60 so as to receive supply of the sales item indicated by the validation card 50 associated with the validation card code included in the validation request information. The customer terminal 60 which sends the PIN code to the company server 40 supplying the sales item indicated by the validation card 50 reads the validation card information, thus the troublesome labor taken by the customer to input various kinds of information to the customer terminal 60 can be reduced. Specifically, the validation card information includes a PIN code of the validation card 50 and the Web address of a Website at which the PIN code is input. In a case of the validation card 50 with a variable system, the validation card information includes a PIN code of the validation card 50, the Web address of a Website at which the PIN code is input and an amount of the validation card 50.

Further, the communication control section 1013 may receive the PIN code displayed on the customer terminal 60 as the validation card information. The validation card information may not include the Web address. The communication control section 1013 may receive the Web address of the Website to which the PIN code can be sent as the validation card information. The validation card information may not include the PIN code.

The NFC control section 1014 controls the short-distance wireless communication such as an NFC through the non-contact card reader/writer 105. The NFC control section 1014 serving as a writing module writes, through the non-contact card reader/writer 105, the validation card information received by the communication control section 1013 in the validation card information storage area 525a of the validation card 50. Specifically, the NFC control section 1014 writes the validation card information including the PIN code, the Web address and the amount in the validation card information storage area 525a of the validation card 50. In this way, the customer terminal 60 that reads the validation card information can display the PIN code. Further, the customer terminal 60 that reads the validation card information can display the Website indicated by the Web address. The customer terminal 60 that reads the validation card information can display the amount purchased through the validation card 50.

The printing control section 1015 controls the printer 107 to print a receipt.

Next, the functional components of the store server 20 are described. The CPU of the control section 201 copies or decompresses programs in the storage section 205 on the RAM and operates according to the programs to generate each functional section shown in FIG. 11 on the RAM. Specifically, the store server 20 includes, as functional sections, a communication control section 2011 and an information generating section 2012.

The communication control section 2011 controls the communication interface 203 to connect with the in-store network N1 and the network N2. In this way, the communication control section 2011 communicates with the POS terminal 10 and the validating server 30. Specifically, the communication control section 2011 receives the validation request information from the POS terminal 10. Then, the communication control section 2011 sends the validation request information to the validating server 30. Further, the communication control section 2011 receives validation reply information from the validating server 30. The validation reply information refers to information indicating the reply of the validation request information. The validation reply information includes a validation card code of the validation request information and a PIN code associated with the validation card code. The communication control section 2011 sends the validation card information generated by the information generating section 2012 to the POS terminal 10.

The communication control section 2011 sends the amount information received by the store server 20 to the company server 40 if the amount information is received from the POS terminal 10.

The information generating section 2012 generates the validation card information if the communication control section 2011 receives the validation reply information. Specifically, the information generating section 2012 extracts the validation card code and the PIN code from the validation reply information if the communication control section 2011 receives the validation reply information. The information generating section 2012 refers to the commodity master file 205a to extract the Web address associated with the validation card code. The information generating section 2012 generates the validation card information including the PIN code and the Web address. The information generating section 2012 generates the validation card information including a PIN code, a Web address and amount information in a case of the validation card 50 with the variable system.

Next, the functional components of the validating server 30 are described. The CPU of the control section 301 copies or decompresses programs in the storage section 305 on the RAM and operates according to the programs to generate each functional section shown in FIG. 11 on the RAM. Specifically, the validating server 30 includes, as functional sections, a communication control section 3011, a validation setting section 3012 and a validation determination section 3013.

The communication control section 3011 controls the communication interface 303 to connect with the network N2. In this way, the communication control section 3011 communicates with the store server 20 and the company server 40. Specifically, the communication control section 3011 receives the validation request information from the store server 20. Then, the communication control section 3011 sends the validation reply information to the store server 20. The communication control section 3011 receives determination request information from the company server 40. The determination request information refers to information that requests determination of whether or not it is the PIN code validated. Thus, the determination request information includes a PIN code serving as a determination target. The communication control section 3011 sends determination result information to the company server 40. The determination result information refers to information indicating the result of the valid/invalid determination of the PIN code.

The validation setting section 3012 validates the validation state associated with the validation card code if the validation request information from the store server 20 is received. Specifically, the validation setting section 3012 extracts the validation card code from the validation request information if the validation request information from the store server 20 is received. Then, the validation setting section 3012 validates the validation state associated with the validation card code with the use of the validation card master file 305a.

The validation determination section 3013 refers to the validation card master file 305a to determine whether or not the received PIN code is valid if the determination request information from the company server 40 is received. Then, the validation determination section 3013 generates the determination result information according to the result of the determination.

Next, the functional components of the company server 40 are described. The CPU of the control section 401 copies or decompresses programs in the storage section 405 on the RAM and operates according to the programs to generate each functional section shown in FIG. 11 on the RAM. Specifically, the company server 40 includes, as functional sections, a communication control section 4011, an amount setting section 4012 and a commodity supply section 4013.

The communication control section 4011 controls the communication interface 403 to connect with the network N2. In this way, the communication control section 4011 communicates with the customer terminal 60 and the validating server 30. Specifically, the communication control section 4011 receives authentication request information from the customer terminal 60. The authentication request information refers to information indicating the request for the authentication of the PIN code. The authentication request information includes the PIN code. The communication control section 4011 sends the determination request information to the validating server 30. The communication control section 4011 receives the determination result information from the validating server 30. The communication control section 4011 sends authentication reply information to the customer terminal 60. The authentication reply information refers to information indicating the result of the authentication of the PIN code contained in the authentication request information. The communication control section 4011 receives the amount information from the store server 20.

The amount setting section 4012 sets the amount indicated by the amount information to the commodity contained in the PIN code master file 405a if the communication control section 4011 receives the amount information.

The commodity supply section 4013 supplies the commodity indicated by the validation card 50 if the determination result information indicating that the PIN code of the validation card 50 is validated is received.

Next, functional components of the customer terminal 60 are described. The CPU of the control section 601 copies or decompresses programs in the storage section 606 on the RAM and operates according to the programs to generate each functional section shown in FIG. 11 on the RAM. Specifically, the customer terminal 60 includes, as functional sections, an NFC control section 6011, a display control section 6012 and a communication control section 6013.

The NFC control section 6011 controls a short-distance wireless communication such as the NFC through the non-contact card reader 602. Specifically, The NFC control section 6011 reads the validation card information from the validation card information storage area 525a of the validation card 50 held over to the non-contact card reader 602.

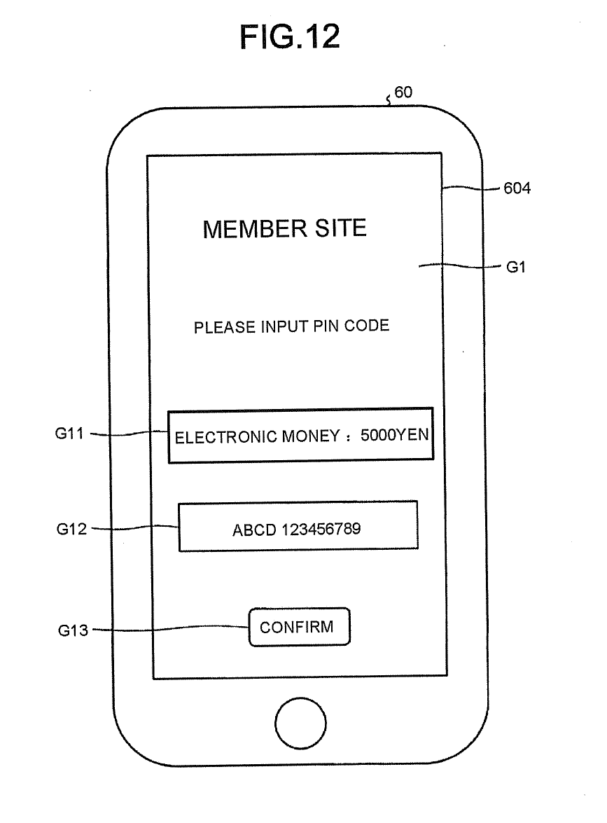

The display control section 6012 controls the display of a screen on the display section 604. The display control section 6012 displays a PIN code input screen G1 indicated by the Web address if the NFC control section 6011 reads the validation card information from the validation card 50. FIG. 12 is an illustration diagram exemplifying the PIN code input screen G1. The PIN code input screen G1 is used to input the PIN code to be sent to the company server 40. The PIN code input screen G1 shown in FIG. 12 includes an amount display column G11, a PIN code input column G12 and a confirmation button G13. The amount display column G11 displays the amount purchased with the validation card 50. In a case of the validation card 50 with the variable system, any amount can be set by the customer. Thus, the customer can refer to the PIN code input screen G1 to confirm the purchased amount even if the customer forgets the purchased amount carelessly. The PIN code input column G12 is used for the input of the PIN code. The confirmation button G13 is used to confirm the PIN code input to the PIN code input column G12. The PIN code input column G12 shown in FIG. 12 indicates a state in which ‘ABCD123456789’ is input as the PIN code. The display control section 6012 displays the PIN code input screen G1 on which the PIN code is input to the PIN code input column G12 if the validation card information includes the PIN code.

The display control section 6012 displays the PIN code if the Web address is not contained in the validation card information read by the NFC control section 6011. In this way, the customer can grasp the PIN code of the validation card 50. The display control section 6012 displays the Website to which the PIN code can be sent if the PIN code is not contained in the validation card information read by the NFC control section 6011. In this way, it is possible for the customer to reduce the input job for displaying the Website. The display control section 6012 displays the amount set by the customer in a case in which the validation card 50 adopts the variable system and the Web address is not contained in the validation card information read by the NFC control section 6011. In this way, it is not necessary for the customer to note or memorize the set amount.

The communication control section 6013 controls the communication interface 603 to connect with the network N2. In this way, the communication control section 6013 communicates with the company server 40. Specifically, the communication control section 6013 sends an authentication request information including the PIN code to the company server 40 through the PIN code input screen G1 (Website). Then, the communication control section 6013 receives the authentication reply information from the company server 40.

Next, the checkout processing executed according to a program by the control section 101 of the POS terminal 10 according to the foregoing embodiment is described.

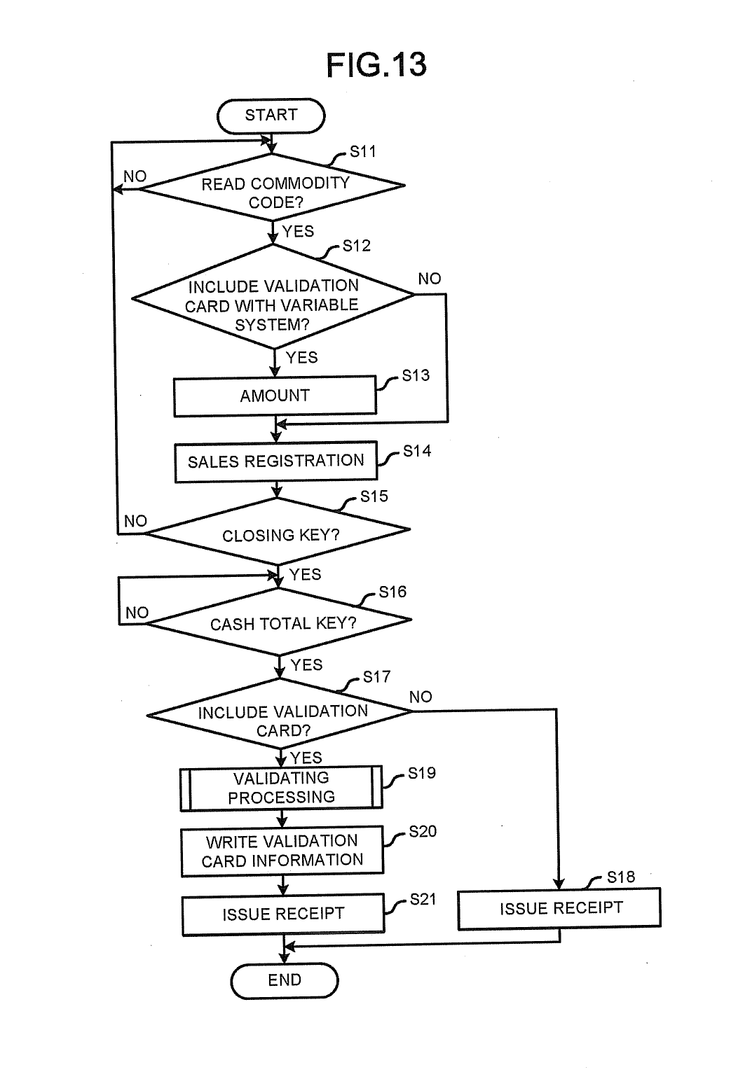

FIG. 13 is a flowchart illustrating procedures of the checkout processing executed by the control section 101 of the POS terminal 10 according to the program. The checkout processing refers to a processing relating to the payment of a commodity to be purchased by the customer.

First, the control section 101 (sales registration section 1011) of the POS terminal 10 determines whether or not the commodity code can be read through the barcode reader 103 (Act S11). If the commodity code cannot be read (No in Act S11), the control section 101 (sales registration section 1011) of the POS terminal 10 waits for the execution of the checkout processing.

On the other hand, if the commodity code can be read (Yes in Act S11), the control section 101 (sales registration section 1011) of the POS terminal 10 determines whether or not the commodity the commodity code of which is read is a validation card 50 with a variable system (Act S12).

If the commodity is the validation card 50 with the variable system (Yes in Act S12), the control section 101 (sales registration section 1011) of the POS terminal 10 sends the amount information indicating the amount set by the customer to the company server 40 through the store server 20 (Act S13). In this way, the control section 401 (amount setting section 4012) of the company server 40 sets the amount indicated in the amount information in the PIN code master file 405a.

On the other hand, if the commodity is not the validation card 50 with the variable system (No in Act S12), the control section 101 (sales registration section 1011) of the POS terminal 10 proceeds to Act S14.

Then, the control section 101 (sales registration section 1011) of the POS terminal 10 sales-registers the input commodity code (Act S14).

Next, the control section 101 (sales registration section 1011) of the POS terminal 10 determines whether or not the press-operation on the closing key is detected (Act S15). If the press-operation on the closing key is not detected (No in Act S15), the control section 101 (sales registration section 1011) of the POS terminal 10 proceeds to Act S11.

On the other hand, if the press-operation on the closing key is detected (Yes in Act S15), the control section 101 (sales registration section 1011) of the POS terminal 10 determines whether or not the press-operation on the cash total key for confirming the payment is detected (Act S16). If the press-operation on the cash total key is not detected (No in Act S16), the control section 101 (sales registration section 1011) of the POS terminal 10 waits for the execution of the checkout processing.

On the other hand, if the press-operation on the cash total key is detected (Yes in Act S16), the control section 101 (validation request section 1012) of the POS terminal 10 determines whether or not the commodity that is sales-registered contains the validation card 50 (Act S17).

If the validation card 50 is not contained in the sales-registered commodity (No in Act S17), the control section 101 (printing control section 1015) of the POS terminal 10 prints a receipt (Act S18).

If the validation card 50 is contained in the sales-registered commodity (Yes in Act S17), the control section 101 of the POS terminal 10 executes a validating processing described later (Act S19).

Next, the control section 101 (NFC control section 1014) of the POS terminal 10 writes the validation card information received in the validating processing in the validation card information storage area 525a of the validation card 50 (Act S20).

The control section 101 (printing control section 1015) of the POS terminal 10 prints a receipt (Act S21).

As stated above, the control section 101 of the POS terminal 10 executes the checkout processing.

Next, the validating processing executed according to programs by each apparatus of the validating system 1 according to the foregoing embodiment is described.

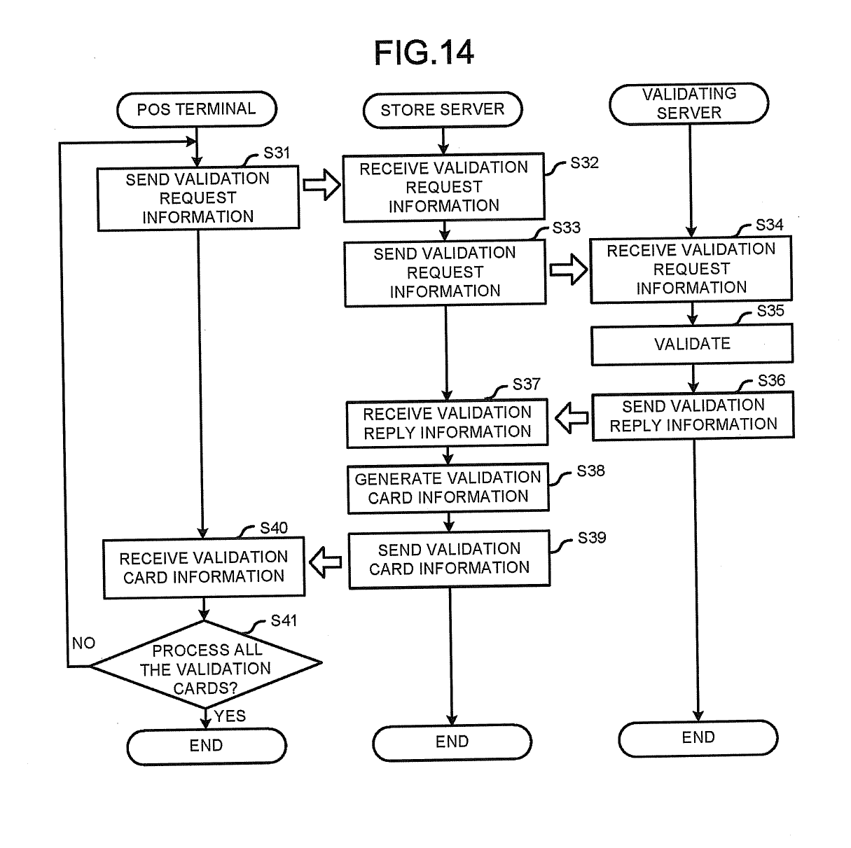

FIG. 14 is a flowchart illustrating procedures of a validating processing executed by each apparatus of the validating system 1 according to the programs.

First, the control section 101 (communication control section 1013) of the POS terminal 10 sends the validation request information including the validation card code of the sales-registered validation card 50 to the store server 20 (Act S31).

Next, the control section 201 (communication control section 2011) of the store server 20 receives the validation request information (Act S32). The control section 201 (communication control section 2011) of the store server 20 sends the received validation request information to the validating server 30 (Act S33).

The control section 301 (communication control section 3011) of the validating server 30 receives the validation request information (Act S34). The control section 301 (validation setting section 3012) of the validating server 30 refers to the validation card master file 305a to validate the validation state associated with the validation card code contained in the validation request information (Act S35).

Next, the control section 301 (communication control section 3011) of the validating server 30 sends the validation reply information to the store server 20 (Act S36).

The control section 201 (communication control section 2011) of the store server 20 receives the validation reply information (Act S37). The control section 201 (information generating section 2012) of the store server 20 generates the validation card information (Act S38). The control section 201 (communication control section 2011) of the store server 20 sends the generated validation card information to the POS terminal 10 (Act S39).

The control section 101 (communication control section 1013) of the POS terminal 10 receives the validation card information (Act S40). The control section 101 (validation request section 1012) of the POS terminal 10 determines whether or not the validating processing is executed for all of the sales-registered validation cards 50 (Act S41).

If the validating processing is executed for not all the sales-registered validation cards 50 (No in Act S41), the control section 101 (validation request section 1012) of the POS terminal 10 proceeds to Act S31.

On the other hand, if the validating processing is executed for all the sales-registered validation cards 50 (Yes in Act S41), the control section 101 (validation request section 1012) of the POS terminal 10 terminates the validating processing.

In this way, each apparatus of the validating system 1 executes the validating processing.

Next, the commodity providing processing executed according to programs by each apparatus of the validating system 1 according to the foregoing embodiment is described. The commodity providing processing refers to a processing that makes it possible to charge electronic money or download a commodity such as music or a game.

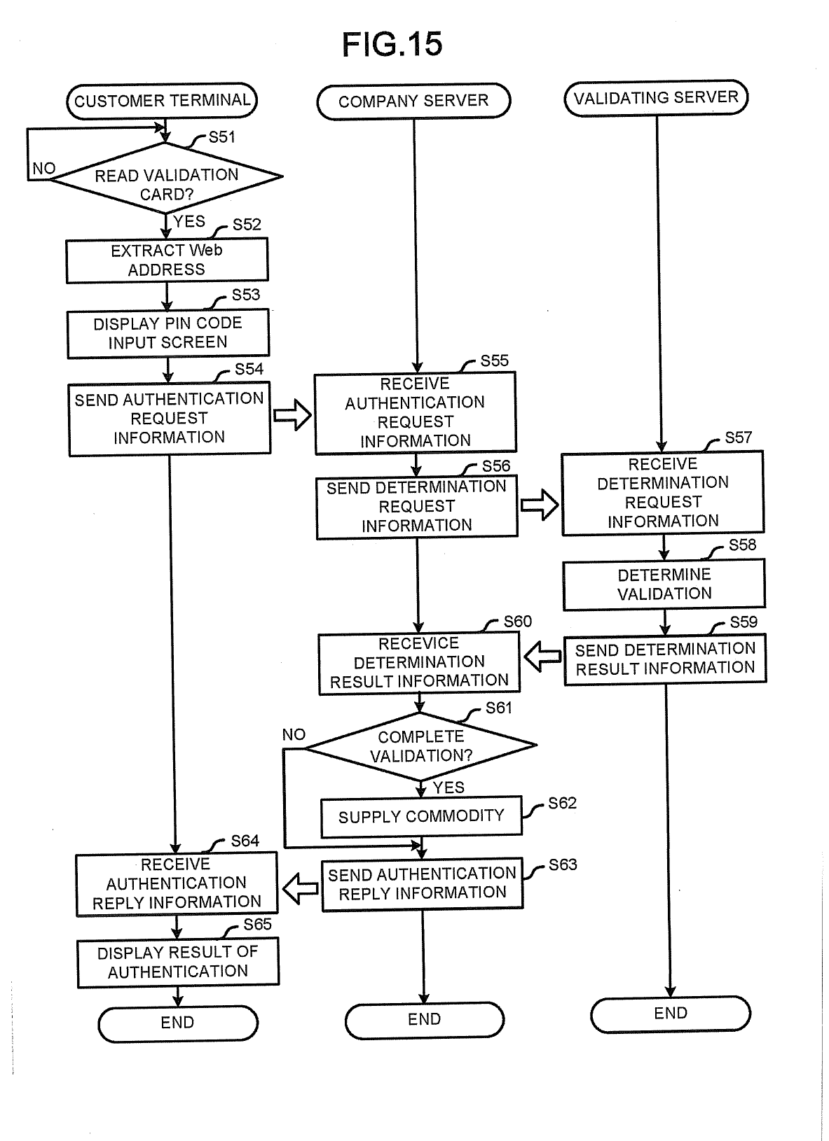

FIG. 15 is a flowchart illustrating procedures of a commodity providing processing executed by each apparatus of the validating system 1 according to the programs.

First, the control section 601 (NFC control section 6011) of the customer terminal 60 determines whether or not the validation card information stored in the validation card information storage area 525a of the validation card 50 can be read (Act S51). If the validation card information cannot be read (No in Act S51), the control section 601 (NFC control section 6011) of the customer terminal 60 waits for the execution of the commodity providing processing.

On the other hand, if the validation card information can be read (Yes in Act S41), the control section 601 (NFC control section 6011) of the customer terminal 60 extracts the Web address from the validation card information (Act S52).

Next, the control section 601 (display control section 6012) of the customer terminal 60 displays the PIN code input screen G1 on the display section 604 (Act S53). Then, the control section 601 (communication control section 6013) of the customer terminal 60 sends the authentication request information to the company server 40 if an input for confirming the PIN code displayed on the PIN code input screen G1 is operated (Act S54).

The control section 401 (communication control section 4011) of the company server 40 receives the authentication request information (Act S55). Next, the control section 401 (communication control section 4011) of the company server 40 sends the determination request information to the validating server 30 (Act S56).

The control section 301 (communication control section 3011) of the validating server 30 receives the determination request information (Act S57). The control section 301 (validation determination section 3013) of the validating server 30 refers to the PIN code master file 405a to determine whether or not the validated state of the PIN code contained in the determination request information is validated (Act S58). Next, the control section 301 (communication control section 3011) of the validating server 30 sends the determination result information to the company server 40 (Act S59).

Next, the control section 401 (communication control section 4011) of the company server 40 receives the determination result information (Act S60). The control section 401 (commodity supply section 4013) of the company server 40 determines whether or not the PIN code is validated according to the determination result information (Act S61).

If the PIN code is validated (Yes in Act S61), the control section 401 (commodity supply section 4013) of the company server 40 supplies the commodity indicated by the validation card 50 to the customer (Act S62).

On the other hand, if the PIN code is not validated (No in Act S61), the control section 401 (commodity supply section 4013) of the company server 40 does not supply the commodity to the customer.

Next, the control section 401 (communication control section 4011) of the company server 40 sends the authentication reply information to the customer terminal 60 (Act S63).

The control section 601 (communication control section 6013) of the customer terminal 60 receives the authentication reply information (Act S64). Next, the control section 601 (display control section 6012) of the customer terminal 60 displays the authentication reply information on the display section 604 (Act S65).

In this way, each apparatus of the validating system 1 executes the commodity providing processing.

As stated above, according to the POS terminal 10 of the present embodiment, the sales registration section 1011 receives an input for confirming the payment of the validation card 50 through the keyboard 102 if the payment of the validation card 50 is received by the store clerk. The communication control section 1013 sends the validation request information to the validating server 30 if the payment of the validation card 50 is confirmed. The communication control section 1013 receives the validation card information read by the customer terminal 60 that sends the PIN code as a reply. The NFC control section 1014 writes the validation card information in the validation card information storage area 525a of the validation card 50. The customer terminal 60 for inputting the PIN code at a Website can read out the validation card information stored in the validation card information storage area 525a of the validation card 50. In this way, as it is not necessary for the customer to operate the customer terminal 60 to input the PIN code, the POS terminal 10 of the present embodiment can reduce input job to the customer terminal 60.

While certain embodiments have been described, these embodiments have been presented by way of example only, and are not intended to limit the scope of the invention. Indeed, the novel embodiments described herein may be embodied in a variety of other forms; furthermore, various omissions, substitutions and changes in the form of the embodiments described herein may be made without departing from the spirit of the invention. The accompanying claims and their equivalents are intended to cover such forms or modifications as would fall within the scope and spirit of the invention.

In the foregoing embodiment, it is described that the customer terminal 60 inputs the PIN code at the Website to send the PIN code to the company server 40. However, the input destination of the PIN code is not limited to the Website. For example, the customer terminal 60 may input the PIN code to an input column of an application program to send the PIN code to the company server 40.

The programs executed in each apparatus of the foregoing embodiment and modifications may be installed into a recording medium (a ROM or a storage section) of each apparatus in advance to be supplied; however, it is not limited to this. For example, the programs may be recorded in a computer-readable recording medium such as a CD-ROM, an FD (Flexible Disk), a CD-R or a DVD (Digital Versatile Disk) in the form of installable or executable file to be supplied. Further, the recording medium is not limited to a medium independent from a computer or an incorporated system and may be a recording medium that downloads programs transmitted by an LAN or an internet and stores or temporarily stores downloaded programs.

The programs executed in each apparatus of the foregoing embodiment and modifications may be stored in a computer connected with a network such as the internet and may be supplied by being downloaded via the network or may be supplied or distributed via a network such as the internet.

What is claimed is:

1. A commodity sales data processing apparatus, comprising:
a commodity sales module configured to execute a commodity sales processing relating to payment of a validation commodity of which a PIN (Personal Identification Number) code is validated at the time the payment is confirmed;
a sending module configured to send identification information capable of identifying the validation commodity after the payment is confirmed in the commodity sales module;
a receiving module configured to receive validation commodity information read by an information processing apparatus that sends the PIN code to a server of a company that provides a sales item in order to receive the sales item indicated by the validation commodity identified by the identification information sent from the sending module; and
a writing module configured to write the validation commodity information received by the receiving module in an IC (Integrated Circuit) tag on the validation commodity.

2. The commodity sales data processing apparatus according to claim 1, wherein
the receiving module receives the PIN code to be displayed on the information processing apparatus as the validation commodity information.

3. The commodity sales data processing apparatus according to claim 1, wherein
the receiving module receives a Web address of a Website to which the PIN code is sent as the validation commodity information.

4. The commodity sales data processing apparatus according to claim 2, wherein
the receiving module receives a Web address of a Website to which the PIN code is sent as the validation commodity information.

5. The commodity sales data processing apparatus according to claim 3, wherein
the receiving module receives information for displaying the Website on which the PIN code to be sent to the server is being input to an input column thereof as the validation commodity information.

6. The commodity sales data processing apparatus according to claim 1, wherein
the receiving module receives an amount that is supplied through the transmission of the PIN code as the validation commodity information.

7. A method for processing a validation commodity by a commodity sales data processing apparatus, including:
executing a commodity sales processing relating to payment of a validation commodity of which a PIN (Personal Identification Number) code is validated at the time the payment is confirmed;
sending identification information capable of identifying the validation commodity after the payment is confirmed;
receiving validation commodity information read by an information processing apparatus that sends the PIN code to a server of a company that provides a sales item to receive the sales item indicated by the validation commodity identified by the identification information; and
writing the validation commodity information in an IC tag on the validation commodity.
